(19) United States
(12) Patent Application Publication
(10) Pub. No.: US 2024/0073391 A1
(43) Pub. Date: Feb. 29, 2024

(54) INFORMATION PROCESSING APPARATUS, INFORMATION PROCESSING METHOD, AND PROGRAM

(71) Applicant: SONY GROUP CORPORATION, TOKYO (JP)

(72) Inventors: TOMOHIKO GOTOH, TOKYO (JP); RYO FUKAZAWA, TOKYO (JP); KAZUNORI ASAYAMA, TOKYO (JP)

(21) Appl. No.: 18/260,753

(22) PCT Filed: Jan. 11, 2022
(86) PCT No.: PCT/JP2022/000506

§ 371 Date: Jul. 7, 2023

(30) Foreign Application Priority Data
Jan. 19, 2021 (JP) 2021-006261

(51) Int. Cl. H04N 13/122; G06F 3/0485; G06T 7/20; H04N 13/305; H04N 13/324; H04N 13/344; H04N 13/366; H04N 13/00

(52) U.S. Cl. CPC H04N 13/122; G06F 3/0485; G06T 7/20; H04N 13/305; H04N 13/324; H04N 13/344; H04N 13/366; H04N 2013/0081

(57) ABSTRACT

An information processing apparatus according to an embodiment of the present technology includes a display controller. The display controller detects an interference object on the basis of a position of a point of view of a user and a position of at least one object that is displayed on a display that performs stereoscopic display depending on the point of view of the user, the interference object interfering with an outer edge that is in contact with a display region of the display; and controls display of the interference object that is performed on the display such that stereovision contradiction related to the interference object is suppressed.

### TECHNICAL FIELD

The present technology relates to an information processing apparatus, an information processing method, and a program that can be applied to, for example, control on stereoscopic display.

### BACKGROUND ART

Technologies that enable stereoscopic display of stereoscopically displaying an object in a virtual three-dimensional space have been developed in the past. For example, Patent Literature 1 discloses an apparatus that displays an object stereoscopically using a display screen on which stereoscopic display can be performed. This apparatus performs animation display of gradually increasing an amount of depth that is measured from a display screen and at which an object that is attracting attention from a user is situated. This enables the user to gradually adjust the focus according to the animation display. This makes it possible to reduce, for example, an uncomfortable feeling or a feeling of exhaustion that is brought to the user (for example, paragraphs [0029], [0054], [0075], and [0077] of the specification, and FIG. 4 in Patent Literature 1).

### CITATION LIST

### Patent Literature

Patent Literature 1: Japanese Patent Application Laid-open No. 2012-133543

### DISCLOSURE OF INVENTION

### Technical Problem

Stereoscopic display may bring, for example, an uncomfortable feeling to a user depending on how a displayed object looks to the user. Thus, there is a need for a technology that enables stereoscopic display that only imposes a low burden on a user.

In view of the circumstances described above, it is an object of the present technology to provide an information processing apparatus, an information processing method, and a program that enable stereoscopic display that only imposes a low burden on a user.

### Solution to Problem

In order to achieve the object described above, an information processing apparatus according to an embodiment of the present technology includes a display controller.

The display controller detects an interference object on the basis of a position of a point of view of a user and a position of at least one object that is displayed on a display that performs stereoscopic display depending on the point of view of the user, the interference object interfering with an outer edge that is in contact with a display region of the display; and controls display of the interference object that is performed on the display such that stereovision contradiction related to the interference object is suppressed.

In the information processing apparatus, at least one object is displayed on a display that performs stereoscopic display depending on a point of view of a user. From among the at least one object, an interference object that interferes with an outer edge that is in contact with a display region of the display is detected on the basis of a position of the point of view of the user and a position of each object. Then, display of the interference object that is performed on the display is controlled such that contradiction that arises when the interference object is stereoscopically viewed is suppressed. This enables stereoscopic display that only imposes a low burden on a user.

The display controller may control the display of the interference object such that a state in which at least a portion of the interference object is hidden by the outer edge is resolved.

The display region may be a region on which a pair of object images generated correspondingly to a left eye and a right eye of the user is displayed, the pair of object images being generated for each object. In this case, the display controller may detect, as the interference object, an object that is from among the at least one object and of which an object image of the pair of object images protrudes from the display region.

The display controller may calculate a score that represents a level of the stereovision contradiction related to the interference object.

On the basis of the score, the display controller may determine whether to control the display of the interference object.

The display controller may calculate the score on the basis of at least one of the area of a portion of the object image of the interference object that is situated outside of the display region, a depth that is measured from the display region and at which the interference object is situated, or a set of a speed and a direction of movement of the interference object.

The display controller may determine a method for controlling the display of the interference object on the basis of attribute information regarding an attribute of the interference object.

The attribute information may include at least one of information that indicates whether the interference object moves, or information that indicates whether the interference object is operatable by the user.

The display controller may perform first processing of adjusting display of the entirety of the display region in which the interference object is situated.

The first processing may be at least one of processing of bringing a display color closer to black at a location situated closer to an edge of the display region, or processing of scrolling the entirety of a scene displayed on the display region.

When the interference object is operatable by the user, the display controller may perform the processing of scrolling the entirety of a scene displayed on the display region.

The display controller may perform second processing of adjusting an appearance of the interference object.

The second processing may be at least one of processing of bringing a color of the interference object closer to a color of a background, processing of increasing a degree of transparency of the interference object, processing of deforming the interference object, or processing of making the interference object smaller in size.

The display controller may perform third processing of adjusting a behavior of the interference object.

The third processing may be at least one of processing of changing a direction of movement of the interference object, processing of increasing a speed of the movement of the interference object, processing of controlling the movement of the interference object, or processing of not displaying the interference object.

When the interference object is operatable by the user, the display controller may perform the processing of controlling the movement of the interference object.

The information processing apparatus may further include a content execution section that executes a content application used to present the at least one object. In this case, processing performed by the display controller may be processing caused by a run-time application to be performed, the run-time application being used to execute the content application.

The display may be a stationary apparatus that performs stereoscopic display that is visible to the user with naked eyes.

An information processing method according to an embodiment of the present technology is an information processing method that is performed by a computer system, the information processing method including: detecting an interference object on the basis of a position of a point of view of a user and a position of at least one object that is displayed on a display that performs stereoscopic display depending on the point of view of the user, the interference object interfering with an outer edge that is in contact with a display region of the display; and controlling display of the interference object that is performed on the display such that stereovision contradiction related to the interference object is suppressed.

A program according to an embodiment of the present technology causes a computer system to perform a process including:
detecting an interference object on the basis of a position of a point of view of a user and a position of at least one object that is displayed on a display that performs stereoscopic display depending on the point of view of the user, the interference object interfering with an outer edge that is in contact with a display region of the display; and controlling display of the interference object that is performed on the display such that stereovision contradiction related to the interference object is suppressed.

### BRIEF DESCRIPTION OF DRAWINGS

FIG. 1 schematically illustrates an appearance of a stereoscopic display that includes an information processing apparatus according to an embodiment of the present technology.

FIG. 2 is a block diagram illustrating an example of a functional configuration of the stereoscopic display.

FIG. 3 is a schematic diagram used to describe stereovision contradiction that arises on the stereoscopic display.

FIG. 4 is a flowchart illustrating an example of a basic operation of the stereoscopic display.

FIG. 5 is a flowchart illustrating an example of rendering processing.

FIG. 6 schematically illustrates an example of calculating an object region.

FIG. 7 schematically illustrates examples of calculating a quality assessment score.

FIG. 8 is a table in which examples of adjustment processing performed on an interference object are given.

FIG. 9 schematically illustrates an example of vignette processing.

FIG. 10 schematically illustrates an example of scrolling processing.

FIG. 11 schematically illustrates an example of color changing processing.

FIG. 12 schematically illustrates an example of movement direction changing processing.

FIG. 13 schematically illustrates an example of a configuration of an HMD that is a stereoscopic display apparatus according to another embodiment.

FIG. 14 schematically illustrates a field of view of a user who is wearing the HMD.

### MODE(S) FOR CARRYING OUT THE INVENTION

Embodiments according to the present technology will now be described below with reference to the drawings.

[Configuration of Stereoscopic Display]

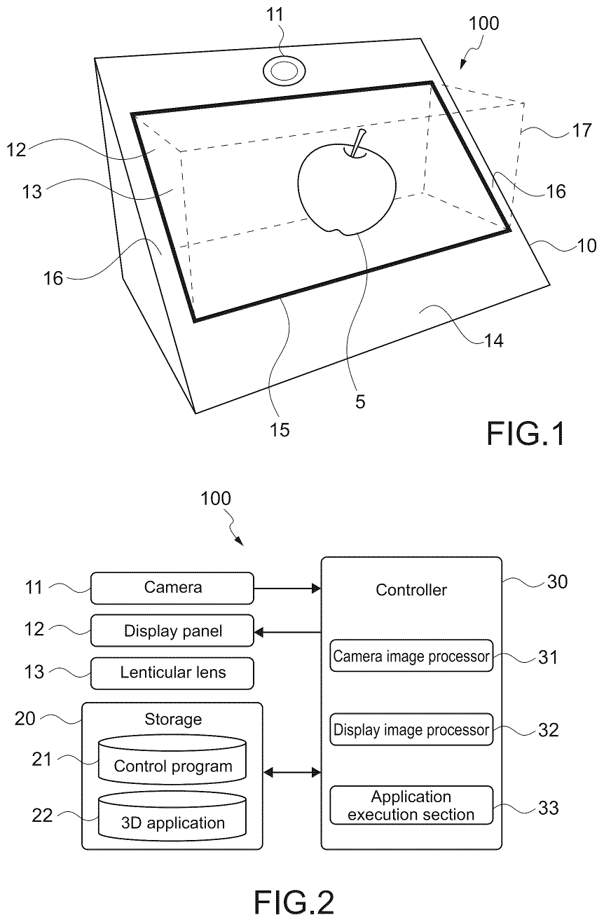

FIG. 1 schematically illustrates an appearance of a stereoscopic display 100 that includes an information processing apparatus according to an embodiment of the present technology. The stereoscopic display 100 is a stereoscopic display apparatus that performs stereoscopic display depending on a point of view of a user. The stereoscopic display 100 is a stationary apparatus that is used by being placed on, for example, a table, and stereoscopically displays, to a user who is viewing the stereoscopic display 100, at least one object 5 that is included in, for example, video content.

In the present embodiment, the stereoscopic display 100 is a light field display. The light field display is a display apparatus that dynamically generates a left parallax image and a right parallax image according to, for example, a position of a point of view of a user. Auto-stereoscopy is provided by these parallax images being respectively displayed to a left eye and a right eye of a user.

As described above, the stereoscopic display 100 is a stationary apparatus that performs stereoscopic display that is visible to a user with naked eyes.

As illustrated in FIG. 1, the stereoscopic display 100 includes a housing portion 10, a camera 11, a display panel 12, and lenticular lens 13.

The housing portion 10 is a housing that accommodates therein each component of the stereoscopic display 100, and includes an inclined surface 14. The inclined surface 14 is formed to be inclined with respect to an on-placement surface on which the stereoscopic display 100 (the housing portion 10) is placed. The camera 11 and the display panel 12 are provided to the inclined surface 14.

The camera 11 is an image-capturing device that captures an image of a face of a user who is viewing the display panel 12. The camera 11 is arranged as appropriate, for example, at a position at which an image of a face of a user can be captured. In FIG. 1, the camera 11 is arranged in a middle portion of the inclined surface 14 above the display panel 12.

For example, a digital camera that includes, for example, an image sensor such as a complementary-metal-oxide semiconductor (CMOS) sensor or a charge coupled device (CCD) sensor is used as the camera 11.

A specific configuration of the camera 11 is not limited, and, for example, a multiple lens camera such as a stereo camera may be used. Further, for example, an infrared camera that irradiates infrared light to capture an infrared image, or a ToF camera that serves as a ranging sensor may be used as the camera 11.

The display panel 12 is a display element that displays parallax images used to stereoscopically displays the object 5.

The display panel 12 is a panel rectangular as viewed in a plan view, and is arranged on the inclined surface 14. In other words, the display panel 12 is arranged in a state of being inclined as viewed from a user. For example, this enables a user to view the stereoscopically displayed object 5 horizontally and vertically.

A display element (a display) such as a liquid crystal display (LCD), a plasma display panel (PDP), or an organic electroluminescence (EL) panel is used as the display panel 12.

A region that is a surface of the display panel 12 and on which a parallax image is displayed is a display region 15 of the stereoscopic display 100. FIG. 1 schematically illustrates a region that is indicated by a black bold line and corresponds to the display region 15. Further, a portion, of the inclined surface 14, that is situated outside of the display region 15 and is in contact with the display region 15 is referred to as an outer edge 16. The outer edge 16 is a real object that is adjacent to the display region 15. For example, a portion (such as an outer frame of the display panel 12) that is included in the housing and is arranged to surround the display region 15 is the outer edge 16.

The lenticular lens 13 is used by being attached to the surface of the display panel 12 (the display region 15), and is a lens that only refracts, in a specific direction, a light ray that exits the display panel 12. For example, the lenticular lens 13 has a structure in which elongated convex lenses are adjacently arranged, and is arranged such that a direction in which the convex lens extends is parallel to an up-and-down direction of the display panel 12.

For example, the display panel 12 displays thereon a two-dimensional image that is formed of left and right parallax images that are each divided into strips in conformity to the lenticular lens. This two-dimensional image is formed as appropriate, and this makes it possible to display respective parallax images to a left eye and a right eye of a user.

As described above, the stereoscopic display 100 is provided with a lenticular-lens display unit (the display panel 12 and the lenticular lens 13) that controls an exit direction for each display pixel.

Moreover, a display method used to perform stereoscopy is not limited.

For example, parallax barrier in which a shielding plate is provided for each set of display pixels to split a light ray into light rays that are incident on the respective eyes, may be used. Further, for example, a polarization method in which a parallax image is displayed using, for example, polarized glasses, or a frame sequential method in which switching is performed between parallax images for each frame to display the parallax image using, for example, liquid crystal glasses may be used.

The stereoscopic display 100 makes it possible to stereoscopically view at least one object 5 using left and right parallax images displayed on the display region 15 of the display panel 12.

A left-eye parallax image and a right-eye parallax image that represent each object 5 are hereinafter respectively referred to as a left-eye object image and a right-eye object image. For example, the left-eye object image and the right-eye object image are a pair of images respectively obtained when an object is viewed from a position corresponding to a left eye and when the object is viewed from a position corresponding to a right eye.

Thus, the same number of pairs of object images as the number of objects 5 is displayed on the display region 15. As described above, the display region 15 is a region on which a pair of object images generated correspondingly to a left eye and a right eye of a user is displayed, the pair of object images being generated for each object 5.

Further, in the stereoscopic display 100, the object 5 is stereoscopically displayed in a preset virtual three-dimensional space (hereinafter referred to as a display space 17). Thus, for example, a portion of the object 5 that is situated beyond the display space 17 is not displayed. FIG. 1 schematically illustrates a space corresponding to the display space 17 using a dotted line.

Here, a space that has a shape of a rectangular parallelepiped is used as the display space 17, where two short sides of the display region 15 that are respectively situated on the left and on the right correspond to diagonal lines of surfaces of the rectangular parallelepiped that face each other. Further, each surface of the display space 17 is set to be parallel to or orthogonal to an arrangement surface on which the stereoscopic display 100 is arranged. This makes it possible to easily recognize, for example, a back-and-forth direction, an up-and-down direction, and a bottom of the surface display space 17.

Note that a shape of the display space 17 is not limited, and may be set discretionarily according to, for example, the application of the stereoscopic display 100.

FIG. 2 is a block diagram illustrating an example of a functional configuration of the stereoscopic display 100.

The stereoscopic display 100 further includes a storage 20 and a controller 30.

The storage 20 is a nonvolatile storage device, and, for example, a solid state drive (SSD) or a hard disk drive (HDD) is used as the storage 20.

The storage 20 serves as a data storage that stores therein a 3D application 21. The 3D application 21 is a program that executes or plays back 3D content on the stereoscopic display 100. The 3D application 21 includes, as executable data, a three-dimensional shape of the object 5, attribute information regarding an attribute of the object 5 described later, and the like. The execution of the 3D application results in presenting at least one object 5 on the stereoscopic display 100.

The program and data of the 3D application 21 are read as necessary by an application execution section 33 described later. In the present embodiment, the 3D application 21 corresponds to a content application.

Further, the storage 20 stores therein a control program 22. The control program 22 is a program used to control an operation of the overall stereoscopic display 100. Typically, the control program 22 is a run-time application that runs on the stereoscopic display 100. For example, the 3D application 21 is executed by the respective functional blocks implemented by the control program 22 operating cooperatively.

Moreover, various data, various programs, and the like that are necessary for an operation of the stereoscopic display 100 are stored in the storage 20 as necessary. A method for installing, for example, the 3D application 21 and the control program 22 on the stereoscopic display 100 is not limited.

The controller 30 controls operations of the respective blocks of the stereoscopic display 100. The controller 30 is configured by hardware, such as a CPU and a memory (a RAM and a ROM), that is necessary for a computer. Various processes are performed by the CPU loading, into the RAM, the control program 22 stored in the storage 20 and executing the control program 22. In the present embodiment, the controller 30 corresponds to an information processing apparatus.

For example, a programmable logic device (PLD) such as a field programmable gate array (FPGA), or another device such as an application specific integrated circuit (ASIC) may be used as the controller 30.

In the present embodiment, a camera image processor 31, a display image processor 32, and the application execution section 33 are implemented as functional blocks by the CPU of the controller 30 executing the control program 22 according to the present embodiment. Then, an information processing method according to the present embodiment is performed by these functional blocks. Note that, in order to implement each functional block, dedicated hardware such as an integrated circuit (IC) may be used as appropriate.

The camera image processor 31 detects, in real time and in an image captured by the camera 11, positions of left and right points of view of a user (a point-of-view position). Here, the point-of-view position is a three-dimensional spatial position in a real space.

For example, a face of a user who is viewing the display panel 12 (the display region 15) is authenticated with respect to an image captured by the camera 11 to calculate, for example, three-dimensional coordinates of a position of a point of view of a user. A method for detecting a point-of-view position is not limited, and, for example, processing of estimating a point of view may be performed using, for example, machine learning, or a point of view may be detected using, for example, pattern matching.

Information regarding a position of a point of view of a user is output to the display image processor 32.

The display image processor 32 controls display of, for example, the object 5 that is performed on the stereoscopic display 100. Specifically, a parallax image displayed on the display panel 12 (the display region 15) is generated in real time according to a position of a point of view of a user, the point-of-view position being output by the camera image processor 31. Here, a parallax image (an object image) of each object 5 is generated as appropriate, and this results in display of the object 5 being controlled.

In the present embodiment, the lenticular lens 13 is used, as described above. In this case, the display image processor 32 adjusts, using calibration, a correspondence relationship between a position of a pixel on the display panel 12 and a direction in which refraction is performed by the lenticular lens 13. This adjustment determines pixels used to display left and right parallax images (object images) according to, for example, a position of a point of view of a user. On the basis of a result of the adjustment, each of the left and right parallax images are divided into strips, and the strips of the left and right parallax images are combined to generate a division image. Data of the division image is output to the display panel 12 as final output data.

In the present embodiment, the display image processor 32 detects an interference object from among at least one object 5 displayed on the stereoscopic display 100.

Here, the interference object is the object 5 interfering with the outer edge 16 (such as the outer frame of the display panel 12) in contact with the display region 15. For example, the object 5 appearing to be overlapping the outer edge 16 in stereovision, as viewed from a point of view of a user, is the interference object. When such an interference object is displayed with no change, stereovision contradiction described later may arise.

Specifically, on the basis of a position of a point of view of a user and a position of at least one object 5 displayed on the stereoscopic display 100, the display image processor 32 detects an interference object that interferes with the outer edge 16 in contact with the display region 15 of the stereoscopic display 100.

As described above, the stereoscopic display 100 stereoscopically displays thereon the object 5 according to a point of view of a user. Thus, even when the object 5 is arranged to be situated in the display space 17, the object 5 may appear to be overlapping the outer edge 16 depending on from which direction the object 5 is viewed. Therefore, whether the object 5 situated in the display space 17 is an interference object, is determined by a position of a point of view of a user and a position of the object 5 (a position, in the display space 17, at which the object 5 is arranged).

The display image processor 32 determines whether each object 5 interferes with the outer edge 16, on the basis of a position of a point of view of a user and a position of the object 5. Accordingly, an interference object is detected.

Further, the display image processor 32 controls display of an interference object that is performed on the stereoscopic display 100 such that stereovision contradiction related to an interference object is suppressed.

When, for example, an interference object is detected, a method for representing the interference object, a position of the interference object, a shape of the interference object, and the like are automatically adjusted in order to suppress stereovision contradiction that arises due to the interference object interfering with the outer edge 16. Processing of controlling display of an interference object is performed when, for example, an object image of each object 5 is generated. This makes it possible to prevent stereovision contradiction from arising.

In the present embodiment, the display image processor 32 corresponds to a display controller.

The application execution section 33 reads a program and data of the 3D application 21 from the storage 20 (a data storage), and executes the 3D application 21. In the present embodiment, the application execution section 33 corresponds to a content execution section.

For example, details of the 3D application 21 are interpreted to generate information regarding a position and an operation of the object 5 in the display space 17 according to the details. This information is output to the display image processor 32. Note that a final position and an operation of the object 5 may be changed according to, for example, the adjustment performed by the display image processor 32.

The 3D application 21 is executed on a device-dedicated run-time application. For example, when the 3D application 21 has been developed using a game engine, a run-time application for the game engine is used by being installed on the storage 20.

The display image processor 32 described above is implemented as a portion of a function of such a run-time application. In other words, processing performed by the display image processor 32 is processing caused by a run-time application to be performed, the run-time application being used to execute the 3D application. This makes it possible to suppress, for example, stereovision contradiction regardless of, for example, the type of 3D application.

[Stereovision Contradiction]

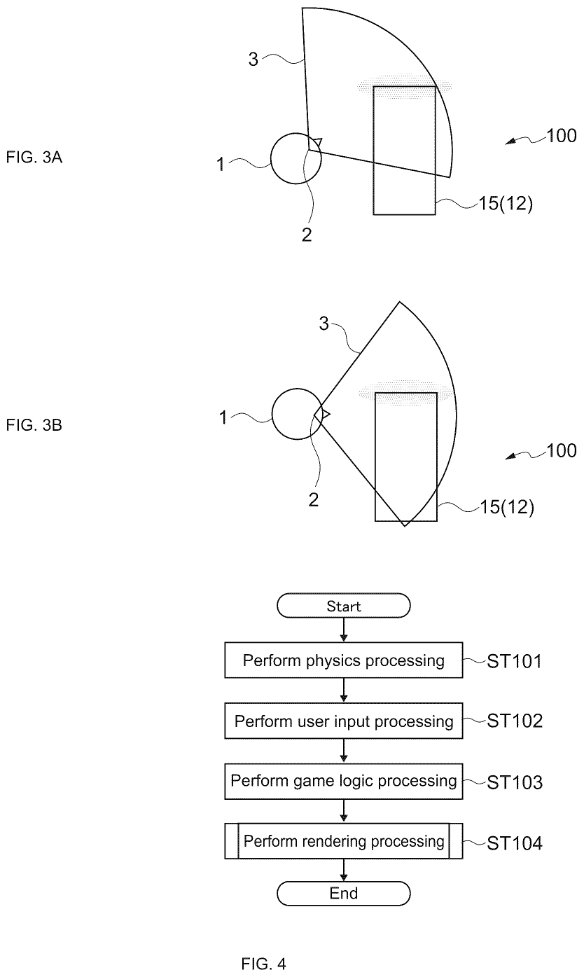

FIG. 3 is a schematic diagram used to describe stereovision contradiction that arises on the stereoscopic display 100. A and B of FIG. 3 each schematically illustrate the display region 15 of the stereoscopic display 100, a head of a user 1 who is viewing the display region 15, and a field of view 3 that is covered by a point of view 2 of the user 1. A and B of FIG. 3 include different positions (positions of a point of view) of the user 1 and different orientations of the head (directions of a line of sight) of the user 1. Here, the points of view 2 for a left eye and a right eye of the user 1 are represented by one point in order to simplify the description.

Stereoscopic display makes it possible to cause a user to feel as if the object 5 were displayed at a depth of which a level is different from a level of a surface (the display region 15) on which an image is actually displayed.

The stereovision contradiction is, for example, contradiction in information related to a depth perceived by a user.

When, for example, a stereoscopically viewed virtual object (an object displayed on the display region 15) and a real object (such as a housing that surrounds the display region 15) are adjacent to each other, there may be contradiction between which of the objects is situated in front of the other object that is determined due to an overlap of the objects, and a depth provided in stereovision. Such a state refers to stereovision contradiction. The stereovision contradiction may bring an uncomfortable feeling or a feeling of exhaustion to the user 1, and this may result in the user getting sickness.

The stereoscopic display 100, which is a light field display, can display the object 5 situated in front of or behind the display region 15 such that the object 5 is oriented in various directions, as described above. Due to such hardware characteristics, stereovision contradiction perceived with two eyes may be easily noticeable.

The following are two primary factors.

First, an edge (the outer edge 16) of the display region 15 is more likely to be situated at the center of the field of view 3 of the user 1.

The stereoscopic display 100 itself is fixed. However, there is a certain amount of flexibility in a position and an orientation of a face (the head) of the viewing user 1 standing in front of the stereoscopic display 100. Thus, there is a good possibility that the edge of the display region 15 will be situated at the center of the field of view 3.

A left edge (an upper portion in the figure) of the display region 15 is situated at the center of the field of view 3 when the user 1 turns his/her head to the left from the front of the display region 15, as illustrated in, for example, A of FIG. 3. Further, the left edge (the upper portion in the figure) of the display region 15 is also situated at the center of the field of view 3 when the user 1 is looking at a left portion of the display region 15 in front, as illustrated in, for example, B of FIG. 3.

Thus, stereovision contradiction tends to be seen easily on the stereoscopic display 100.

Secondly, the object 5 corresponding to a virtual object can be displayed in front of the display region 15.

On the stereoscopic display 100, a portion of the display space 17 enabling stereovision is situated in front of the display panel 12 (the display region 15), as described with reference to FIG. 1. The object 5 arranged in this region looks as if the object 5 were situated in front of the display region 15.

For example, when a portion of the object 5 situated in front of the display region 15 overlaps the edge of the display region 15, the object 5 is hidden by the outer edge 16 (for example, a bezel of the display panel 12). Consequently, the outer edge 16 corresponding to a real object looks as if the outer edge 16 were situated in front, and the object 5 corresponding to a virtual object looks as if the object 5 were situated in back. In this case, a state in depth provided in stereovision is the reverse of which of the objects is situated in front of the other object that is determined due to an overlap of the objects. Accordingly, stereovision contradiction arises.

Further, the display region 15 itself is easily perceived at the edge of the display region 15 due to the presence of the outer edge 16 corresponding to a real object. This results in being easily aware of contradiction related to depth parallax. This may also result in making the user 1 feel, for example, uncomfortable with how the object 5 looks to the user 1 when the object 5 is displayed behind the display region 15.

Note that a head-mounted display (HMD) is an example of a device that performs stereoscopic display using a parallax image. As in the case of the HMD, a display on which a parallax image is displayed is situated in front of two eyes at all times. Thus, portions of an edge of a display region of the display are respectively situated near outer portions (right and left ends) of the field of view for naked eyes of a person who is wearing the HMD (refer to FIG. 14).

Further, there is a guideline of not arranging, from the medical perspective, a virtual object at a position with a large angle of convergence in virtual reality (VR) content played back by an HMD. In other words, a virtual object viewed through an HMD is primarily arranged further away than the surface of a display (a display region). Thus, the stereovision contradiction described above is less likely to be noticeable in the case of an HMD.

As described above, the stereoscopic display 100 enables more flexible representation in stereovision than devices such as HMDs. On the other hand, the depth contradiction described above may arise on the stereoscopic display 100. Further, for example, stereovision contradiction may arise when the object 5 in the display space 17 is situated on a side of the edge of the display region 15 and in front of the display region 15 and when the user 1 turns his/her face toward the edge of the display region 15. On the other hand, it is difficult to predict how the viewing user 1 acts. Thus, for example, it is difficult for the 3D application 21 to control, in advance, arising of stereovision contradiction.

Thus, in the present embodiment, display control is performed upon executing the 3D application 21, such that a position of a point of view of the user 1 and a position of each object 5 are grasped in real time using a run-time application for the stereoscopic display 100 to dynamically resolve or mitigate stereovision contradiction. This makes it possible to suppress, for example, stereovision contradiction without, for example, specifically responding for each 3D application 21, and thus to improve a viewing experience.

[Operation of Stereoscopic Display]

FIG. 4 is a flowchart illustrating an example of a basic operation of the stereoscopic display 100. Processing illustrated in FIG. 4 is, for example, loop processing performed repeatedly for each frame during execution of the 3D application 21. For example, a flow of this processing is set as appropriate according to a run-time application for, for example, a game engine used to develop the 3D application 21.

First, physics processing is performed (Step 101). The physics processing is, for example, physical computation used to calculate the behavior of each object 5. For example, processing of moving the object 5 is performed following, for example, falling of the object 5, and processing of deforming the object 5 is performed following collision of the objects 5. Moreover, specific details of the physics processing are not limited, and any physical computation may be performed.

Next, user input processing is performed (Step 102). The user input processing is, for example, processing of reading details of an operation that is input by the user 1 using, for example, a specified input device. For example, information regarding, for example, a movement direction and a movement speed of the object 5 depending on the details of the operation input by the user 1 is received. Alternatively, a command or the like that is input by the user 1 is received as appropriate. Moreover, any information input by the user 1 is read as appropriate.

Next, game logic processing is performed (Step 103). The game logic processing is, for example, processing of reflecting, in the object 5, a logic that is set for the 3D application 21. When, for example, a character is caused to jump in response to input being performed by the user 1, processing of, for example, changing a movement direction and a shape (for example, a pose) of the object 5 corresponding to the character is performed. Moreover, the behavior and the like of each object 5 are set as appropriate according to a preset logic.

Steps of the physics processing, the user input processing, and the game logic processing described above are performed by, for example, the application execution section 33. Further, when the game logic processing has been performed, arrangement, a shape, and the like of the object 5 to be displayed in the display space 17 are determined. Note that what has been described above may be changed when subsequent processing is performed.

Next, rendering processing is performed (Step 104). The rendering processing is processing of performing rendering on each object 5 on the basis of the arrangement, the shape, and the like of the object 5 that are determined by performing the processes of Steps 101 to 103. Specifically, parallax images (object images) and the like of each object 5 are generated according to a position of a point of view of the user 1.

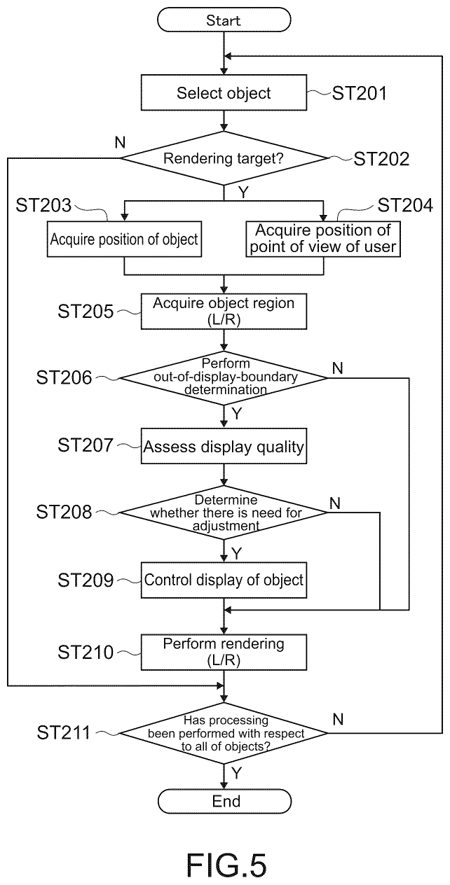

FIG. 5 is a flowchart illustrating an example of the rendering processing. Processing illustrated in FIG. 5 is processing included in the rendering processing in Step 104 of FIG. 4.

In the present embodiment, for example, processing of detecting an interference object and processing of controlling display of the interference object that are included in the rendering processing are performed.

First, the object 5 is selected by the display image processor 32 (Step 201). For example, one of the objects 5 included in a result of the game logic processing described above is selected.

Next, it is determined whether the object 5 selected in Step 201 is a rendering target (Step 202). For example, the object 5, which is not arranged in the display space 17, is determined to not be a rendering target (No in Step 202). In this case, the process of Step 211, which will be described later, is performed. Further, for example, the object 5, which is arranged in the display space 17, is determined to be a rendering target (Yes in Step 202).

When the object 5 has been determined to be a rendering target, processing of acquiring a position of the rendering-target object 5 (Step 203), and processing of acquiring a position of a point of view of the user 1 (Step 204) are performed in parallel.

In Step 203, the display image processor 32 reads, from the result of the game logic processing, a position at which the object 5 is arranged.

In Step 204, the camera image processor 31 detects a position of a point of view of the user 1 in an image captured using the camera 11. The display image processor 32 reads the detected position of a point of view of the user 1.

The position of the object 5 and the position of a point of view of the user 1 are, for example, spatial positions in a three-dimensional coordinate system set on the basis of the display space 17.

Next, the display image processor 32 acquires object regions (Step 205). The object region is, for example, a region on which each of object images that are left and right parallax images of the object 5 is displayed on the display region 15.

Here, the object region is calculated on the basis of the position of the object 5 and the position of a point of view of the user 1.

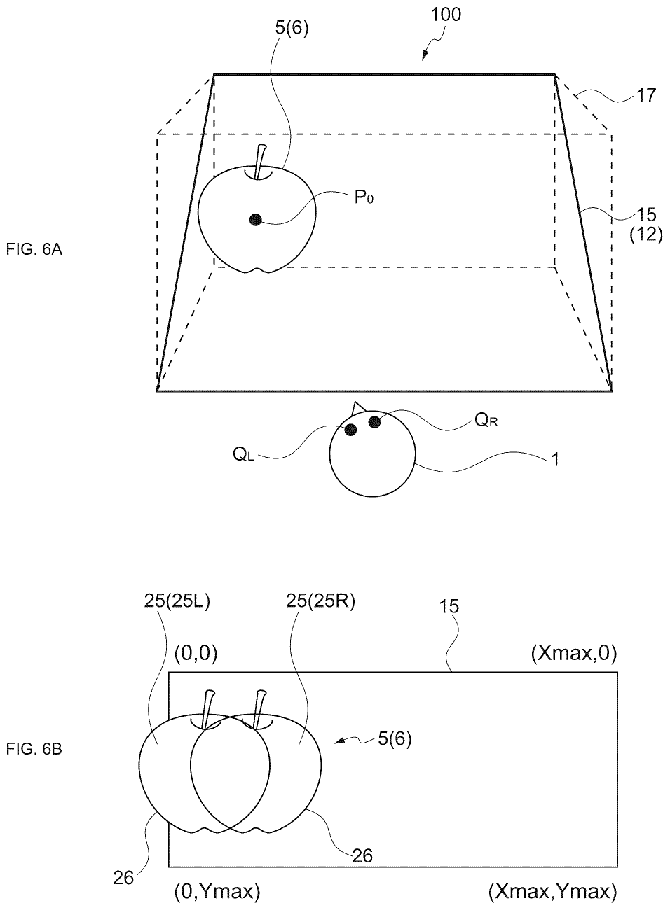

FIG. 6 schematically illustrates an example of calculating an object region. A of FIG. 6 schematically illustrates the object 5 displayed in the display space 17 of the stereoscopic display 100. Further, B of FIG. 6 schematically illustrates object images 25 displayed on the display region 15. The position of the object 5 in the display space 17 is hereinafter referred to as an object position Po. Further, the positions of the points of view for a left eye and a right eye of the user 1 are hereinafter respectively referred to as a point-of-view position Q_{L} and a point-of-view position Q_{R}.

When the object position Po, the position Q_{L} of the point of view of the user, and the position Q_{R} of the point of view of the user are determined, as illustrated in, for example, A of FIG. 6, images (an object image 25L and an object image 25R) to be respectively displayed for the left eye and the right eye of the user 1 are determined. Here, shapes of the object image 25L and the object image 25R, and positions, in the display region 15, at which the object image 25L and the object image 25R are respectively displayed are also determined. This makes it possible to specifically calculate an object region 26 that corresponds to each object image 25.

For example, viewport transformation performed on the object 5 using, for example, a shader program can be used in order to calculate the object region 26. The shader program is a program used to perform, for example, shadow processing on a 3D model, and is used to output a two-dimensional image of a 3D model as viewed from a certain point of view. Further, the viewport transformation is coordinate transformation performed to transform a two-dimensional image on an actual screen surface. Here, the point of view used in the shader program is set for the point-of-view position Q_{L} and the point-of-view position Q_{R}, and the screen surface used for the viewport transformation is set to be a surface including the display region 15.

The processing described above is performed to calculate two object regions 26 respectively corresponding the object image 25L and the object image 25R.

B of FIG. 6 schematically illustrates the object images 25L and 25R representing the object 5 illustrated in A of FIG. 6. A region, in the display region 15, that is occupied by each of the object images 25 is the object region 26.

Note that, in Step 205, there is no need to actually generate (render) the object image 25L and the object image 25R.

When the left and right object regions 26 are calculated, the display image processor 32 performs out-of-display-boundary determination with respect to each object region 26 (Step 206). The display boundary is a boundary of the display region 15, and the out-of-display-boundary determination is determination of whether a portion of each object region 26 is situated outside of the display region 15. It can also be said that this processing is processing of determining the object image 25 protruding from the display region 15.

In the stereoscopic display 100, two parallax images that are left and right parallax images (the object images 25L and 25R) are displayed on one display panel 12 at the same time, as illustrated in, for example, B of FIG. 6.

Here, when the object images 25L and 25R are situated in the display region 15, the object 5 is determined to be situated within the display boundaries (No in Step 206). In this case, the process of Step 210 described later is performed.

Further, when a portion of at least one of the object images 25L and 25R is situated outside of the display region 15, the object 5 is determined to be situated beyond the display boundaries (Yes in Step 206). As described above, the object 5 determined to be situated beyond the display boundaries corresponds to an interference object 6 that interferes with the outer edge 16. In other words, it can also be said that the out-of-display-boundary determination is processing of detecting the interference object 6 from among the objects 5 of display targets.

As described above, the display image processor 32 detects, as the interference object 6, the object 5 being from among at least one object 5 and of which the object image 25 protrudes from the display region 15. This makes it possible to properly detect the object 5 interfering with the outer edge 16.

Here, the object regions 26 respectively corresponding to the object images 25L and 25R are used to perform out-of-display-boundary determination.

Coordinates of a pixel on a surface (a screen surface used for viewport transformation) that includes the display region 15 are hereinafter represented by (x,y). Further, a range of an x coordinate in the display region 15 is represented by x=0 to xₘₐₓ, and a range of a y coordinate in the display region 15 is represented by y=0 to yₘₐₓ, as illustrated in B of FIG. 6. For example, with respect to a pixel that is situated in the object region 26, it is determined whether there is a pixel situated beyond the left or right boundary of the display region 15. In this case, a pixel in which x<0 or a pixel in which x>xₘₐₓ is counted. When the count value is greater than or equal to one, the object 5 is determined to be situated beyond the boundaries.

In the example illustrated in B of FIG. 6, a portion of the object region 26 corresponding to the object image 25L and being from between the object regions 26 respectively corresponding to the object images 25L and 25R is situated beyond the boundary of the display region 15. In this case, the object 5 of a processing target is determined to be situated beyond the display boundaries and determined to be the interference object 6.

Note that, in addition to a pixel situated beyond the left or right boundary, a pixel that is situated beyond an upper or lower boundary may be counted. In this case, a pixel in which y<0 or a pixel in which y>yₘₐₓ is counted.

Further, a count value of a pixel situated beyond the boundaries is recorded as appropriate since the count value is used for subsequently performed processing.

Returning to FIG. 5, when the object 5 has been determined to be situated beyond the display boundaries, that is, when the interference object 6 has been detected, the display image processor 32 assesses the display quality related to the interference object 6 (Step 207).

In this processing, the display image processor calculates a quality assessment score S that represents a level of the stereovision contradiction related to the interference object. The quality assessment score S serves as a parameter that represents a level of viewing trouble due to stereovision contradiction that arises when the user 1 views the stereoscopically displayed interference object 6. In the present embodiment, the quality assessment score S corresponds to a score.

The level of stereovision contradiction is represented by a score, as described above. This makes it possible to, for example, quantify a level of seriousness of a viewing trouble caused due to various factors that are not predictable upon creating the 3D application 21. This results in being able to dynamically determine, upon executing the 3D application 21, whether there is a need to adjust display performed on the stereoscopic display 100.

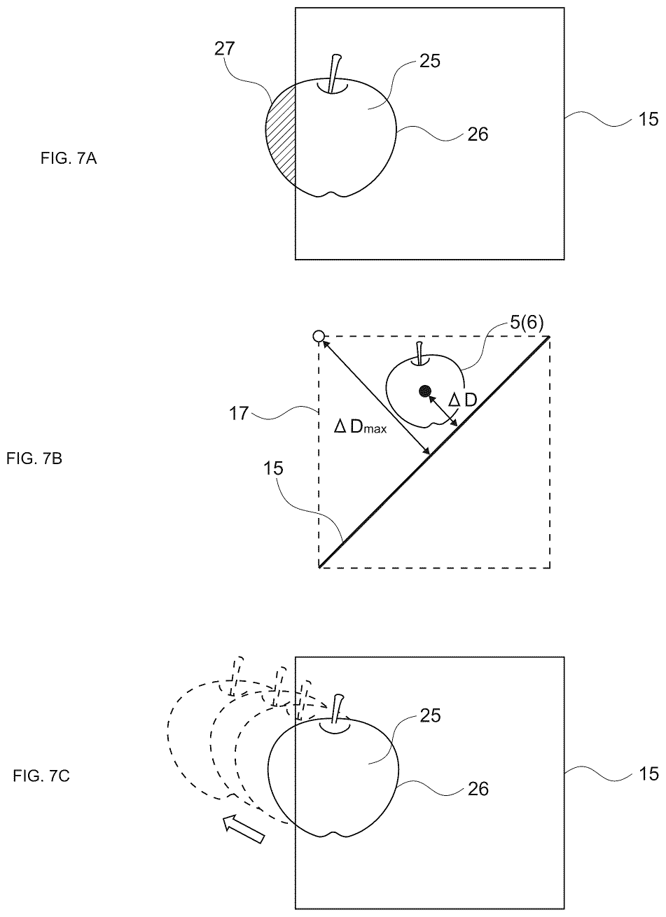

FIG. 7 schematically illustrates examples of calculating a quality assessment score.

A of FIG. 7 is a schematic diagram used to describe an example of calculating a quality assessment score Sₐᵣₑₐ. The Sₐᵣₑₐ is a score using the area of a region (an outer region 27), in the object region 26, that is situated outside of the display region 15, and is calculated in a range in which 0≤Sₐᵣₑₐ≤1. A of FIG. 7 illustrates a hatched region that corresponds to the outer region 27.

Here, the area of a region in the display region 15 is represented by the number N of pixels in the region. The quality assessment score Sₐᵣₑₐ is calculated using a formula indicated below.

$$\begin{matrix}[ Math . 1 ] & \\ {S}_{area} = \frac{{N}_{ext}}{{N}_{total}} & ( 1 )\end{matrix}$$

Here, Next is the number of pixels situated outside of the display region, and is a total number of pixels in the outer region 27. For example, a count value of a pixel that is calculated by performing the out-of-display-boundary determination described above can be used as Next. Further, Nₜₒₜₐₗ is a total number of pixels used to display an object, and is a total number of pixels in the object region 26.

As can be seen from the formula (1), Sₐᵣₑₐ exhibits a larger value if the area of the outer region 27 (a missing portion of an image) in the area obtained upon displaying the entirety of the object region 26 is larger. In other words, Sₐᵣₑₐ exhibits a larger value if the proportion of a portion in the interference object 6 that is situated outside of the display region 15 is greater.

As described above, in the present embodiment, the quality assessment score Sₐᵣₑₐ is calculated on the basis of the area of a portion of an object image of the interference object 6, the portion being situated outside of the display region 15. This makes it possible to assess, for example, a level of stereovision contradiction that arises due to a difference in size between the objects 5.

B of FIG. 7 is a schematic diagram used to describe an example of calculating a quality assessment score S_{depth}. S_{depth} is a score using a depth that is measured from the display region 15 and at which the interference object 6 is situated, and is calculated in a range in which 0≤S_{depth}≤1. B of FIG. 7 schematically illustrates the display space 17 as viewed from a lateral side along the display region 15. The display space 17 corresponds to a rectangular region indicated by a dotted line, and the display region 15 is represented as a diagonal of the region indicated by a dotted line. The depth measured from the display region 15 corresponds to a length of a line perpendicular to the display region 15, and represents an amount by which an object is situated further forward (on the upper left in the figure) than the display region 15, and an amount by which an object is situated further rearward (on the lower right in the figure) than the display region 15.

The quality assessment score S_{depth} is calculated using a formula indicated below.

$$\begin{matrix}[ Math . 2 ] & \\ {S}_{depth} = \frac{Δ D}{Δ {D}_{max}} & ( 2 )\end{matrix}$$

Here, ΔD is a difference in a distance from a zero-parallax surface between the interference object 6 and the zero-parallax surface. The zero-parallax surface is a surface on which a depth parallax exhibits a value of zero, where a position at which an image is displayed and a position at which the depth is perceived coincide. The zero-parallax surface is a surface that includes the display region 15 (the surface of the display panel 12). ΔDₘₐₓ is a difference in a distance from the zero-parallax surface between a position at a maximum depth in the display space 17 and the zero-parallax surface, and is a constant determined by the display space 17. For example, a length of a line perpendicular to the display region 15 from a point at which the depth is largest in the display space 17 (a point on a side of the display space 17 that faces the display region 15) is ΔDₘₐₓ.

As can be seen from the formula (2), S_{depth} exhibits a larger value if a distance between the interference object 6 and a zero-parallax surface in the display region 15 is larger. In other words, S_{depth} exhibits a larger value if the interference object 6 is situated at a greater depth.

As described above, in the present embodiment, the quality assessment score S_{depth} is calculated on the basis of a depth that is measured from the display region 15 and at which the interference object 6 is situated. This makes it possible to assess, for example, a level of stereovision contradiction that arises due to a difference in depth between the objects 5.

C of FIG. 7 is a schematic diagram used to describe an example of calculating a quality assessment score Sₘₒᵥₑ. Sₘₒᵥₑ is a score using a movement speed and a movement direction of the interference object 6, and is calculated in a range in which 0≤Sₘₒᵥₑ≤1. C of FIG. 7 schematically illustrates the object image 25 moving outward from the display region 15. Values of the movement speed and the movement direction of the interference object 6 are determined by, for example, a logic set for the 3D application 21.

The quality assessment score Sₘₒᵥₑ is calculated using a formula indicated below.

$$\begin{matrix}[ Math . 3 ] & \\ {S}_{move} = min \{ 1 , \frac{{F}_{rest}}{FPS} \} & ( 3 )\end{matrix}$$

Here, Fᵣₑₛₜ is the number of frames necessary until the interference object 6 moves to the outside of the display region 15 completely. This exhibits a value calculated from the movement speed and the movement direction of the interference object 6. For example, Fᵣₑₛₜ exhibits a larger value if the movement speed is slower. Further, Fᵣₑₛₜ exhibits a larger value if the movement direction is closer to a direction along a boundary. FPS represents the number of frames per second, and is set to about 60 frames. Of course, the value of FPS is not limited thereto.

As can be seen from the formula (2), Sₘₒᵥₑ exhibits a larger value if the number of frames Fᵣₑₛₜ necessary until the interference object 6 moves to the outside of a screen is larger. Further, Sₘₒᵥₑ exhibits a maximum value of one when Fᵣₑₛₜ exhibits a value greater than or equal to FPS.

As described above, in the present embodiment, the quality assessment score Sₘₒᵥₑ is calculated on the basis of the movement speed and the movement direction of the interference object. For example, Sₘₒᵥₑ exhibits a small value when the interference object 6 becomes invisible in a short time. Conversely, Sₘₒᵥₑ exhibits a large value when there is a possibility that the interference object 6 will be displayed for a long time. Thus, the use of Sₘₒᵥₑ makes it possible to assess, for example, a level of stereovision contradiction that arises according to a period of time for which the interference object 6 is viewed.

In the processing of assessing the display quality, a total assessment score Sₜₒₜₐₗ is calculated on the basis of, for example, the above-described quality assessment scores Sₐᵣₑₐ, S_{depth}, and Sₘₒᵥₑ.

The total assessment score Sₜₒₜₐₗ is calculated using, for example, a formula indicated below.

$$\begin{matrix}[ Math . 4 ] & \\ {S}_{total} = \frac{{S}_{area} + {S}_{depth} + {S}_{move}}{3} & ( 4 )\end{matrix}$$

In the example shown using formula (3), an average of the quality assessment scores is calculated. Thus, a range of the total assessment score Sₜₒₜₐₗ is 0≤Sₜₒₜₐₗ≤1. Note that Sₜₒₜₐₗ may be calculated after each quality assessment score is multiplied by, for example, a weight coefficient.

Further, in this example, a total assessment of three scores (the area, a depth, and movement of an object) is defined as the quality assessment score. However, the total assessment may be determined by one of the three scores or any combination of the three scores.

Returning to FIG. 5, the display image processor 32 determines whether there is a need to adjust the interference object 6 (Step 208). This processing is processing of determining whether to control display of the interference object 6, on the basis of the quality assessment score S described above.

Specifically, threshold determination with respect to the total assessment score Sₜₒₜₐₗ is performed using a preset threshold. When, for example, the total assessment score Sₜₒₜₐₗ is less than or equal to the threshold, a level of viewing trouble due to stereovision contradiction is determined to be low, and thus it is determined that there is no need to adjust the interference object 6 (No in Step 208). In this case, the process of Step 210 described later is performed.

Further, when, for example, the total assessment score Sₜₒₜₐₗ is greater than the threshold, the level of viewing trouble due to stereovision contradiction is determined to be high, and thus it is determined that there is a need to adjust the interference object 6 (Yes in Step 208).

The threshold used to determine whether there is a need for adjustment is set according to, for example, an attribute of the interference object 6 that will be described later.

When it has been determined, as a result of determining whether there is a need for adjustment, that there is a need to adjust the interference object 6, the display image processor 32 performs processing of controlling display of the interference object 6 (Step 209).

In the present embodiment, display of the interference object 6 is controlled such that a state in which at least a portion of the interference object is hidden by the outer edge 16 is resolved. This processing includes, for example, processing of changing, for example, a method for displaying the interference object 6 such that a portion of the object image 25 that corresponds to the outer region 27 is no longer situated outside of the display region 15, and processing of changing, for example, a method for performing display on the entirety of a screen such that the outer region 27 becomes invisible. The control on display of the interference object 6 will be described in detail later.

Next, the display image processor 32 performs processing of performing rendering on each object 5 (Step 210). In this processing, the object images 25L and 25R respectively corresponding to left and right parallax images of the object 5 are each calculated. Note that the object images 25L and 25R calculated here are images in which, for example, information regarding a texture of the object 5 itself is reflected.

A method for calculating the object images 25L and 25R is not limited, and any rendering program may be used.

When rendering is complete, it is determined whether the processing has been performed with respect to all of the objects 5 (Step 211). When, for example, there is an unprocessed object 5 (No in Step 211), the processes of and after Step 201 are performed again.

Further, when, for example, the processing has been performed with respect to all of the objects 5 (Yes in Step 211), processing performed on a target frame is complete, and processing performed on a next frame is started.

[Control on Display of Interference Object]

In the present embodiment, a method for controlling display of the interference object 6 is determined on the basis of attribute information regarding an attribute of the interference object 6. Specifically, adjustment processing performed to adjust display of the interference object 6 is selected with reference to the attribute information.

The attribute information is information that indicates an attribute of the object 5 displayed in the form of an image of content played back by the 3D application 21. For example, the attribute information is set for each object 5 upon creating the 3D application 21 and stored in the storage 20 as data of the 3D application 21.

The attribute information includes information that indicates whether the object 5 moves. For example, attribute information that indicates a mobile object 5 is set for a dynamic object 5 that moves in the display space 17. Further, for example, attribute information that indicates an immobile object 5 is set for a static object 5 that is fixed in the display space 17.

Further, the attribute information includes information that indicates whether an object can be operated by the user 1. For example, attribute information that indicates a player is set for an object, such as a character, that is moved by the user 1 using, for example, a controller. Further, for example, attribute information that indicates a non-player is set for an object that moves regardless of an operation performed by the user 1.

Note that one of those two pieces of information may be set as the attribute information.

When the interference object 6 has been detected, the display image processor 32 reads attribute information corresponding to the interference object 6 from the storage 20. Thus, attribute information regarding an attribute of the interference object 6 includes at least one of information that indicates whether the interference object moves, or information that indicates whether the interference object can be operated by the user.

On the basis of these pieces of information, adjustment processing to be applied is selected.

Note that details of the attribute information are not limited, and other information that indicates an attribute of each object 5 may be set to be the attribute information.

As described above, the selection of adjustment processing suitable for an attribute (such as static/dynamic and player/non-player) of the interference object 6 makes it possible to suppress stereovision contradiction without destroying a concept or a world of content.

Further, the use of an attribute of the interference object 6 and the above-described quality assessment score S in combination makes it possible to set an adjustment method and a level of adjustment for each detected interference object 6. This makes it possible to reduce processing burdens imposed upon performing adjustment processing. Further, the interference object 6 can be moved or changed according to an attribute or a state of the interference object 6.

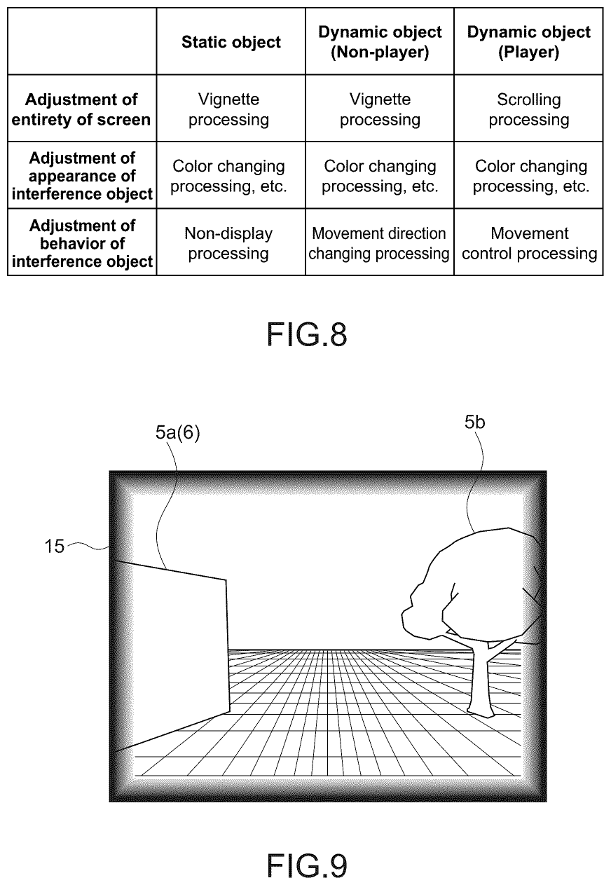

FIG. 8 is a table in which examples of adjustment processing performed on the interference object 6 are given. FIG. 8 illustrates three kinds of adjustment methods for each of three attributes of the interference object 6 (a static object 5, a dynamic object 5 and a non-player, and a dynamic object 5 and a player). Screen adjustment processing, appearance adjustment processing, and behavior adjustment processing are respectively given in the first to third lines from the top for each attribute.

Details of each kind of adjustment processing illustrated in FIG. 8 are specifically described below.

The screen adjustment processing is processing of adjusting display of the entirety of the display region 15 in which the interference object 6 is situated. In this processing, the entirety of a screen of the display region 15 is adjusted. This may also result in a change in display of, for example, the object 5 other than the object 5 corresponding to the interference object 6. In the present embodiment, the screen adjustment processing corresponds to first processing.

In the example illustrated in FIG. 8, vignette processing and scrolling processing are given as examples of the screen adjustment processing.

For example, the vignette processing is performed when the interference object 6 is a static object 5 or when the interference object 6 is a dynamic object 5 and corresponds to a non-player. Further, the scrolling processing is performed when the interference object 6 is a dynamic object 5 and corresponds to a player.

FIG. 9 schematically illustrates an example of the vignette processing. FIG. 9 schematically illustrates a screen (the display region 15) after the vignette processing is performed. Here, one of left and right parallax images is assumed to be displayed, in order to simplify the description. Actually, the left and right parallax images are both displayed on the display region 15.

Static objects 5a and 5b are on the screen illustrated in FIG. 9. It is assumed that, from between the static objects 5a and 5b, the object 5a situated on the left on the screen has been determined to be the interference object 6. In this case, a total assessment score Sₜₒₜₐₗ for the object 5a is calculated, and threshold determination is performed using a threshold threshold_{static} that is set for a static object 5. For example, when Sₜₒₜₐₗ>threshold_{static}, a vignette effect is applied to the entirety of the screen.

The vignette processing (the vignette effect) is processing of bringing the display color closer to black at a location situated closer to the edge of the display region 15. Thus, around a portion, in the display region 15 (on the screen) on which vignette processing has been performed, the display color gradually turns black toward the edge of the display region 15, as illustrated in FIG. 9. Such processing makes it possible to set a depth parallax to zero at the edge of the display region 15. Consequently, it no longer appears that the interference object 6 interferes with the outer edge 16. This makes it possible to resolve stereovision contradiction.

Note that such processing is also effective when the interference object 6 is a dynamic object 5 and corresponds to a non-player.

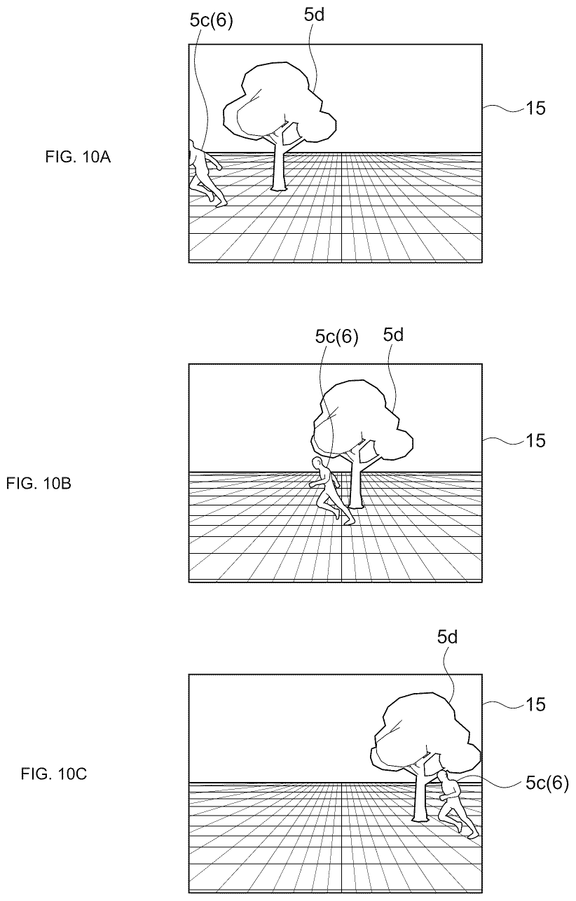

FIG. 10 schematically illustrates an example of the scrolling processing. A to C of FIG. 10 schematically illustrate the screen (the display region 15) changed by the scrolling processing.

A of FIG. 10 illustrates a dynamic object 5c that corresponds to a player that can be operated by the user 1, and a static object 5d. From between the dynamic object 5c and the static object 5d, the object 5c is moving to the left on the screen, and a portion of the object 5c is situated beyond a left edge of the display region 15. In this case, the object 5c is determined to be the interference object 6.

In this case, a total assessment score Sₜₒₜₐₗ for the object 5c is calculated, and threshold determination is performed using a threshold threshold_{player} that is set for the dynamic object 5 corresponding to a player. For example, when Sₜₒₜₐₗ>threshold_{player}, the scrolling processing is performed.

The scrolling processing is processing of scrolling the entirety of a scene displayed on the display region 15. Thus, in the scrolling processing, processing of moving the entirety of the object 5 situated in the display region 15. It can also be said that this is processing of changing a range of a virtual space that is the display space 17 in which display is performed. For example, in B of FIG. 10, the entirety of a screen in a state illustrated in A of FIG. 10 is moved in parallel to the right such that the object 5c is situated at the center of the screen. Consequently, the object 5c no longer protrudes from the display region 15. This makes it possible to prevent stereovision contradiction from arising.

Note that the object 5c continues to move to the left after the screen is scrolled. In such a case, the entirety of the screen may be moved in parallel such that the object 5c is situated on the left on the screen, as illustrated in C of FIG. 10. Consequently, for example, the object 5c takes a long time again to reach a right end of the screen. This makes it possible to reduce the number of scrolling processing performed.

In the present embodiment, when the interference object 6 can be operated by the user 1, the scrolling processing of scrolling the entirety of a scene displayed on the display region 15 is performed, as described above. This makes it possible to constantly display, on a screen, a character (the object 5c) that is operated by the user 1. This results in being able to resolve, for example, stereovision contradiction without interrupting an experience of the user 1.

Note that details of the scrolling processing are not limited, and, for example, the scrolling processing of, for example, rotating a screen may be performed.

The appearance adjustment processing given in the second line in FIG. 8 is processing of adjusting an appearance of the interference object 6. In this processing, the appearance of the interference object 6, such as a color or a shape of the interference object 6, is adjusted. In the present embodiment, the appearance adjustment processing corresponds to second processing.

In the example illustrated in FIG. 8, color changing processing is given as an example of the appearance adjustment processing. Moreover, transparency adjustment processing, shape adjustment processing, or size adjustment processing may be performed as the appearance adjustment processing. These kinds of processing are performed as appropriate according to, for example, an attribute of the interference object 6.

FIG. 11 schematically illustrates an example of the color changing processing. A and B of FIG. 11 schematically illustrate a screen (the display region 15) respectively before and after the color changing processing is applied.

A scene illustrated in A of FIG. 11 is, for example, a scene of forest in which a plurality of trees (a plurality of objects 5e) is arranged, where a dynamic object 5f that represents a character of a butterfly and corresponds to a non-player moves to the left on the screen. The object 5e is, for example, the object 5 of which the entirety has a color set to green (gray on the screen). Further, a color of the object 5f is set to a color (white on the screen) that is different from green used for the background.

It is assumed that, for example, the object 5f that moves to the left on the screen protrudes from the left edge of the display region 15. In this case, the object 5f is determined to be the interference object 6. In this case, a total assessment score Sₜₒₜₐₗ for the object 5f is calculated, and threshold determination is performed using a threshold threshold_{movable} that is set for the dynamic object 5 corresponding to a non-player. For example, the color changing processing is performed when Sₜₒₜₐₗ>threshold_{movable}.

The color changing processing is processing of bringing a color of the interference object 6 closer to a color of the background. It can also be said that this processing is processing of changing, to a color close to a color of the background, a color with which the interference object 6 is displayed, and is processing of making display of the interference object 6 unnoticeable. For example, the display color may be changed gradually or at a time.

For example, in B of FIG. 11, a color of the object 5f determined to be the interference object 6 is adjusted to a color (green here) similar to the color of the object 5e situated around the object 5f. Alternatively, when an image of the background is a colored image, the color of the object 5f is set to a color similar to a color of the image of the background. Consequently, the object 5e becomes unnoticeable. This makes it possible to reduce stereovision contradiction seen by the user 1.

The transparency adjustment processing is processing of increasing a degree of transparency of the interference object 6.

For example, the degree of transparency of the interference object 6 exhibiting a total assessment score Sₜₒₜₐₗ greater than a threshold is changed to be increased. The increase in the degree of transparency results in the interference object 6 exhibiting a reduced sense of reality. This makes it possible to reduce stereovision contradiction seen by the user 1.

For example, processing of making, for example, an enemy character protruding from the display region 15 transparent. This makes it possible to cause the user 1 to understand a position of, for example, the character, and to reduce an uncomfortable feeling brought due to stereovision.

The shape adjustment processing is processing of deforming the interference object 6.

For example, the shape of the interference object 6 exhibiting a total assessment score Sₜₒₜₐₗ greater than a threshold is changed such that the interference object 6 no longer protrudes from the display region 15. Consequently, there exists no portion interfering with the outer edge 16. This makes it possible to resolve stereovision contradiction related to the interference object 6.

This processing is performed on the object 5 of which a shape such as a form or a pose can be changed. For example, processing of deforming a character (such as an amoeba or slime) that has an unfixed shape and protrudes from the display region 15 is performed such that the character is crushed and no longer protrudes from the display region 15. This makes it possible to resolve stereovision contradiction without destroying a world of content.

The size adjustment processing is processing of making the interference object 6 smaller in size.

For example, the interference object 6 exhibiting a total assessment score Sₜₒₜₐₗ greater than a threshold is made smaller in size at a location closer to the edge of the display region 15. This results in becoming more difficult to view the interference object 6. This makes it possible to suppress stereovision contradiction related to the interference object 6. For example, a shell launched by an enemy character is adjusted to be made smaller in size at a location closer to the edge of the display region 15. In this case, it becomes more difficult for the user 1 to view the shell (the interference object 6). This makes it possible to reduce, for example, an uncomfortable feeling brought to the user 1.

The behavior adjustment processing given in the third line in FIG. 8 is processing of adjusting the behavior of the interference object 6. In this processing, the behavior of the interference object 6, such as movement, display, and non-display of the interference object 6, is adjusted. In the present embodiment, the behavior adjustment processing corresponds to third processing.

In the example illustrated in FIG. 8, non-display processing, movement direction changing processing, and movement control processing are given as examples of the behavior adjustment processing.

The non-display processing is performed when, for example, the interference object 6 is a static object 5. Further, the movement direction changing processing is performed when, for example, the interference object 6 is a dynamic object 5 and corresponds to a non-player. Furthermore, the movement control processing is performed when, for example, the interference object 6 is a dynamic object 5 and corresponds to a player.

The non-display processing is processing of not displaying the interference object 6.

It is assumed that, for example, a static object 5 protrudes from the display region 15 and is determined to be the interference object 6. In this case, processing of moving the interference object 6 is processing of moving the object 5 not being supposed to move. This may result in destroying a world of content.

Thus, in the non-display processing, display of a static interference object 6 in which Sₜₒₜₐₗ>threshold_{static} is cancelled. In this case, rendering is not performed on the interference object 6. This makes it possible to resolve stereovision contradiction.

When, for example, a large number of objects 5, such as a large number of objects 5e each representing a tree, is arranged, as illustrated in FIG. 11, disappearance of the object 5 is not noticeable. Thus, the non-display processing is applied. This makes it possible to resolve stereovision contradiction without destroying a world of content.

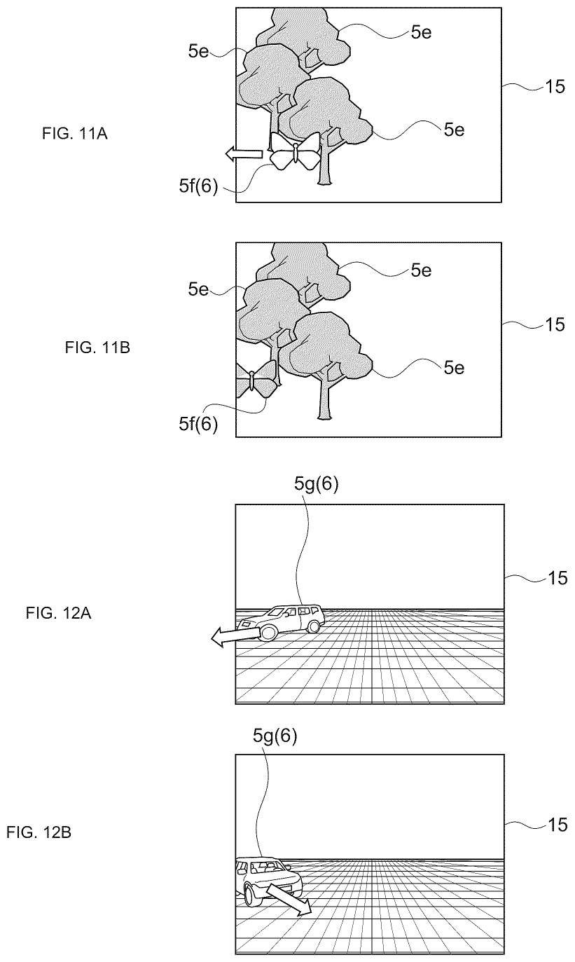

FIG. 12 schematically illustrates an example of movement direction changing processing. A and B of FIG. 12 schematically illustrate a screen (the display region 15) respectively before and after the color changing processing is applied.

In a scene illustrated in A of FIG. 12, a dynamic object 5g that represents an automobile and corresponds to a non-player moves to the left on the screen.

It is assumed that, for example, the object 5g that moves to the left on the screen protrudes from the left edge of the display region 15. In this case, the object 5g is determined to be the interference object 6. In this case, a total assessment score Sₜₒₜₐₗ for the object 5g is calculated, and threshold determination is performed using a threshold threshold_{movable}. For example, the movement direction changing processing is performed when Sₜₒₜₐₗ>threshold_{movable}.

The movement direction changing processing is processing of changing a movement direction of the interference object 6. This processing is processing of changing the movement direction of the interference object 6 such that a state in which the interference object 6 protrudes from the display region 15 is resolved. Consequently, stereovision contradiction only raises for a short period of time. This makes it possible to reduce, for example, an uncomfortable feeling brought to the user 1.

For example, in B of FIG. 12, a movement direction of the object 5g determined to be the interference object 6 is changed from the left direction on the screen to a lower right direction on the screen. This enables the object 5g to continue to move almost without protruding from the display region 15. This makes it possible to reduce stereovision contradiction seen by the user 1.

The movement control processing is processing of controlling movement of the interference object 6.

When, for example, a movement direction or the like of a dynamic object 5, such as a character, that can be operated by the user 1 is adjusted on the system side, the operation performed by the user 1 will not be reflected. Thus, when the dynamic object 5 corresponding to a player is the interference object 6, a range in which the object image 25 does not protrude from the display region 15 is set to be a range in which the dynamic object 5 is movable. This makes it possible to prevent stereovision contradiction from arising.

For example, movement of the interference object 6 (a player object) in which Sₜₒₜₐₗ>threshold_{player} is controlled such that the interference object 6 does not protrude from the display region 15. It is assumed that, for example, the object 5c corresponding to a player and being illustrated in FIG. 10 gets close to a right edge of the display region 15. In this case, movement of the object 5c is controlled such that the object 5c is not movable to the right beyond the boundary of the display region 15.

In the present embodiment, processing of controlling movement of the interference object 6 is performed when the interference object 6 can be operated by the user 1, as described above. When, for example, the interference object 6 moves toward the edge of the display region 15, the interference object 6 is no longer allowed to go ahead at the time of coming into contact with the edge of the display region 15.

Consequently, a character operated by the user 1 no longer protrudes from the display region 15. This results in being able to resolve, for example, stereovision contradiction without interrupting an experience of the user 1.

Further, movement speed adjusting processing is another example of the behavior adjustment processing. The movement speed adjusting processing is processing of increasing a movement speed of the interference object 6.

For example, a shell launched by an enemy character is adjusted to move at a higher speed at a location closer to the edge of the display region 15. The object 5 is caused to move at a high speed at the edge of the display region 15, as described above. Consequently, it becomes more difficult for the user 1 to view the object 5. This makes it possible to reduce, for example, an uncomfortable feeling brought to the user 1.

Note that the respective adjustment processes described above are merely examples, and, for example, other adjustment processing that makes it possible to suppress stereovision contradiction may be performed as appropriate. Further, the correspondence relationship between an attribute of the object 5 and adjustment processing that is illustrated in FIG. 8 is merely an example.

Furthermore, which of the adjustment processes is to be performed for each attribute may be set as appropriate according to, for example, a display state of the object 5 or the type of scene. When, for example, a large number of objects 5 is displayed, processing of not displaying the object 5 is selected, as described above. Alternatively, when an object 5 that is large relative to a screen is displayed, the non-display processing or the like is not performed, and other adjustment processing is applied.

Further, for example, information that is related to, for example, a change restriction and indicates a parameter (such as a movement speed, a movement direction, a shape, a size, and a color) for the object 5 that is not allowed to be changed, may be set. This information is recorded as, for example, attribute information. Such a change restriction is referred to, and this makes it possible to appropriately select applicable adjustment processing.

Moreover, for example, applicable adjustment processing or the like may be set upon creating the 3D application 21. Further, adjustment processing may be selected according to, for example, processing burdens. For example, the screen adjustment processing described above is effective regardless of, for example, an attribute of the object 5. On the other hand, there may be an increase in processing burdens. Thus, when an apparatus exhibits a low degree of computational capability, the appearance adjustment processing, the behavior adjustment processing, or the like can also be performed.

When the controller 30 according to the present embodiment is used, at least one object 5 is displayed on the stereoscopic display 100 performing stereoscopic display depending on a point of view of the user 1, as described above. From among the at least one object 5, the interference object 6 interfering with the outer edge 16 brought into contact with the display region 15 of the stereoscopic display 100 is detected on the basis of a position of a point of view of the user 1 and a position of each object 5. Further, display performed on the stereoscopic display 100 is controlled such that contradiction that arises when the interference object 6 is stereoscopically viewed is suppressed. This enables stereoscopic display that only imposes a low burden on the user 1.

When a three-dimensional object 5 is arranged at an edge of a screen in an apparatus that performs stereoscopic display, stereovision contradiction may arise due to, for example, a missing portion of the object image 25 (a parallax image). This may result in getting sickness or a feeling of exhaustion upon viewing.

Further, when the stereoscopic display 100, which is a light field display, is used, as in the present embodiment, arrangement of the object image 25 is determined according to a position of a point of view of the user 1. The position of a point of view of the user 1 is never known before execution of the 3D application 21. Thus, it is difficult to completely predict, upon creating content, stereovision contradiction that arises due to a relative-position relationship between a position of the object 5 and a position of a point of view of the user 1.

Thus, in the present embodiment, the interference object 6 interfering with the outer edge 16 in contact with the display region 15 is detected using a position of the object 5 and a position of a point of view of the user 1. Further, display of the interference object 6 is dynamically controlled in order to resolve or mitigate stereovision contradiction. This makes it possible to sufficiently suppress, for example, an uncomfortable feeling brought to the user 1 during viewing content, or sickness caused in stereovision. This enables stereoscopic display that only imposes a low burden on the user 1.

Further, a run-time application used upon executing the 3D application 21 controls display of the interference object 6. This makes it possible to reduce burdens imposed on the user 1 without particularly responding on a content basis. This results in being able to sufficiently improve the quality of a viewing experience of the user 1.

Furthermore, in the present embodiment, a method for controlling display of the interference object 6 (adjustment processing) is determined on the basis of an attribute of the interference object 6. This makes it possible to select appropriate adjustment processing according to an attribute of the interference object 6. This results in being able to suppress stereovision contradiction without destroying a concept or a world of content.

Further, in the present embodiment, a quality assessment score for the interference object 6 is calculated. This makes it possible to quantify a level of seriousness of a viewing trouble caused due to various unpredictable factors. This results in being able to dynamically determine whether there is a need to adjust the interference object 6 and to perform adjustment processing at an appropriate timing.

Furthermore, the use of an attribute of the interference object 6 and a quality assessment score in combination makes it possible to set an appropriate adjustment method and an appropriate level of adjustment for each object 5. This results in being able to adjust the interference object 6 naturally, and to provide a high-quality viewing experience without bringing an uncomfortable feeling.

### OTHER EMBODIMENTS

The present technology is not limited to the embodiments described above, and can achieve various other embodiments.

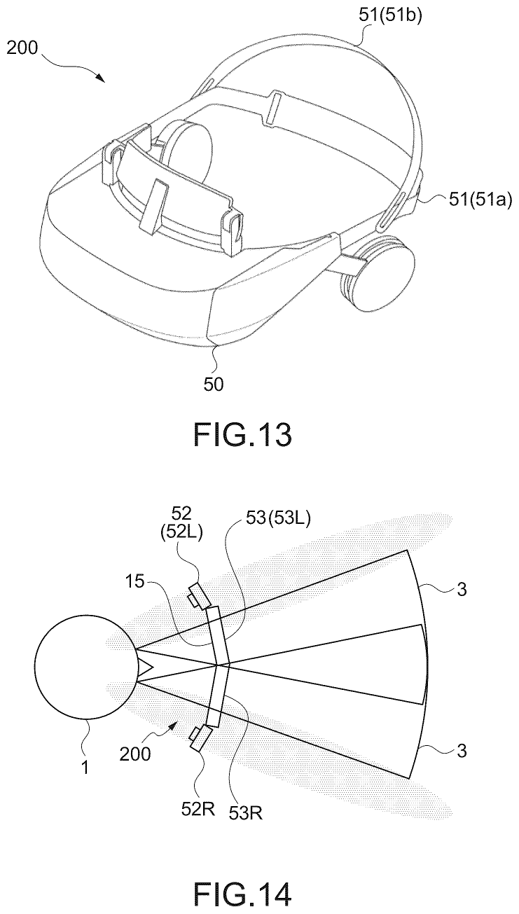

FIG. 13 schematically illustrates an example of a configuration of an HMD that is a stereoscopic display apparatus according to another embodiment. FIG. 14 schematically illustrates the field of view 3 of the user 1 wearing an HMD 200. The HMD 200 includes a base 50, an attachment band 51, an inward-oriented camera 52, a display unit 53, and a controller (not illustrated). The HMD 200 is used by being worn on the head of the user 1, and serves as a display apparatus that performs image display in the field of view of the user 1.

The base 50 is a member arranged in front of left and right eyes of the user 1. The base 50 is configured to cover the field of view of the user 1, and serves as a housing that accommodates therein, for example, the inward-oriented camera 52 and the display unit 53.

The attachment band 51 is attached to the head of the user 1. The attachment band 51 includes a side-of-head band 51a and a top-of-head band 51b. The side-of-head band 51a is connected to the base 50, and is attached to surround the head of the user from the side to the back of the head. The top-of-head band 51b is connected to the side-of-head band 51a, and is attached to surround the head of the user from the side to the top of the head. This makes it possible to hold the base 50 in front of the eyes of the user 1.

The inward-oriented camera 52 includes a left-eye camera 52L and a right-eye camera 52R. The left-eye camera 52L and the right-eye camera 52R are arranged in the base 50 to be respectively capable of capturing images of the left eye and the right eye of the user 1. For example, an infrared camera that captures an image of the eyes of the user 1 is used as the inward-oriented camera 52, where the eyes of the user 1 are illuminated using a specified infrared light source.

The display unit 53 includes a left-eye display 53L and a right-eye display 53R. The left-eye display 53L and the right-eye display 53R respectively display, to the left eye and the right eye of the user 1, parallax images corresponding to the respective eyes.

In the HMD 200, the controller detects a position of a point of view of the user 1 and a direction of a line of sight of the user 1 using images respectively captured by the left-eye camera 52L and the right-eye camera 52R. On the basis of a result of the detection, parallax images (the object images 25) used to display each object 5 are generated. This configuration makes it possible to, for example, perform stereoscopic display calibrated according to a point-of-view position, and input a line of sight.

As illustrated in FIG. 14, in the HMD 200, a left-eye field of view 3L of the user 1 and a right-eye field of view 3R of the user 1 are primarily respectively oriented toward the front of the left-eye display 53L and the front of the right-eye display 53R. On the other hand, when the user 1 moves his/her line of sight, there will be a change in the left-eye field of view 3L and the right-eye field of view 3R. Thus, the edge of the display region 15 of each of the displays 53L and 53R, and an outer frame (the outer edge 16) that is in contact with the display region 15 are easily viewed. In such a case, the stereovision contradiction described with reference to, for example, FIG. 3 is easily seen.

In the HMD 200, the interference object 6 interfering with the outer edge 16 of each of the displays 53L and 53R (the display region 15) is detected, and display of the detected interference object 6 is controlled. Specifically, the adjustment processes described with reference to, for example, FIGS. 8 to 12 are performed. This makes it possible to mitigate or resolve stereovision contradiction that arises at the edge of the display region 15.

As described above, the present technology can also be applied to, for example, a wearable display.

The example in which the controller included in a stereoscopic display or an HMD performs an information processing method according to the present technology has been described above. Without being limited thereto, the information processing method and the program according to the present technology may be executed and the information processing apparatus according to the present technology may be implemented by the controller and another computer working cooperatively, the other computer being capable of communicating with the controller through, for example, a network.

In other words, the information processing method and the program according to the present technology can be executed not only in a computer system that includes a single computer, but also in a computer system in which a plurality of computers operates cooperatively. Note that, in the present disclosure, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

The execution of the information processing method and the program according to the present technology by the computer system includes, for example, both the case in which the detection of an interference object, the control on display of an interference object, and the like are executed by a single computer; and the case in which the respective processes are executed by different computers. Further, the execution of the respective processes by a specified computer includes causing another computer to execute a portion of or all of the processes and acquiring a result of it.

In other words, the information processing method and the program according to the present technology are also applicable to a configuration of cloud computing in which a single function is shared and cooperatively processed by a plurality of apparatuses via a network.

At least two of the features of the present technology described above can also be combined. In other words, the various features described in the respective embodiments may be combined discretionarily regardless of the embodiments. Further, the various effects described above are not limitative but are merely illustrative, and other effects may be provided.

In the present disclosure, expressions such as “same”, “equal”, and “orthogonal” include, in concept, expressions such as “substantially the same”, “substantially equal”, and “substantially orthogonal”. For example, the expressions such as “same”, “equal”, and “orthogonal” also include states within specified ranges (such as a range of +/−10%), with expressions such as “exactly the same”, “exactly equal”, and “completely orthogonal” being used as references.

Note that the present technology may also take the following configurations.
(1) An information processing apparatus, including
   a display controller that
      detects an interference object on the basis of a position of a point of view of a user and a position of at least one object that is displayed on a display that performs stereoscopic display depending on the point of view of the user, the interference object interfering with an outer edge that is in contact with a display region of the display, and
      controls display of the interference object that is performed on the display such that stereovision contradiction related to the interference object is suppressed.
(2) The information processing apparatus according to (1), in which
   the display controller controls the display of the interference object such that a state in which at least a portion of the interference object is hidden by the outer edge is resolved.
(3) The information processing apparatus according to (1) or (2), in which
   the display region is a region on which a pair of object images generated correspondingly to a left eye and a right eye of the user is displayed, the pair of object images being generated for each object, and
   the display controller detects, as the interference object, an object that is from among the at least one object and of which an object image of the pair of object images protrudes from the display region.
(4) The information processing apparatus according to any one of (1) to (3), in which
   the display controller calculates a score that represents a level of the stereovision contradiction related to the interference object.
(5) The information processing apparatus according to (4), in which
   on the basis of the score, the display controller determines whether to control the display of the interference object.
(6) The information processing apparatus according to (4) or (5), in which
   the display controller calculates the score on the basis of at least one of the area of a portion of the object image of the interference object that is situated outside of the display region, a depth that is measured from the display region and at which the interference object is situated, or a set of a speed and a direction of movement of the interference object.
(7) The information processing apparatus according to any one of (1) to (6), in which
   the display controller determines a method for controlling the display of the interference object on the basis of attribute information regarding an attribute of the interference object.
(8) The information processing apparatus according to (7), in which
   the attribute information includes at least one of information that indicates whether the interference object moves, or information that indicates whether the interference object is operatable by the user.
(9) The information processing apparatus according to any one of (1) to (8), in which
   the display controller performs first processing of adjusting display of the entirety of the display region in which the interference object is situated.
(10) The information processing apparatus according to (9), in which
   the first processing is at least one of processing of bringing a display color closer to black at a location situated closer to an edge of the display region, or processing of scrolling the entirety of a scene displayed on the display region.
(11) The information processing apparatus according to (10), in which
   when the interference object is operatable by the user, the display controller performs the processing of scrolling the entirety of a scene displayed on the display region.
(12) The information processing apparatus according to any one of (1) to (11), in which
   the display controller performs second processing of adjusting an appearance of the interference object.
(13) The information processing apparatus according to (12), in which
   the second processing is at least one of processing of bringing a color of the interference object closer to a color of a background, processing of increasing a degree of transparency of the interference object, processing of deforming the interference object, or processing of making the interference object smaller in size.
(14) The information processing apparatus according to any one of (1) to (13), in which
   the display controller performs third processing of adjusting a behavior of the interference object.
(15) The information processing apparatus according to (14), in which
   the third processing is at least one of processing of changing a direction of movement of the interference object, processing of increasing a speed of the movement of the interference object, processing of controlling the movement of the interference object, or processing of not displaying the interference object.
(16) The information processing apparatus according to (15), in which
   when the interference object is operatable by the user, the display controller performs the processing of controlling the movement of the interference object.
(17) The information processing apparatus according to any one of (1) to (16), further including
   a content execution section that executes a content application used to present the at least one object, in which
   processing performed by the display controller is processing caused by a run-time application to be performed, the run-time application being used to execute the content application.
(18) The information processing apparatus according to any one of (1) to (17), in which
   the display is a stationary apparatus that performs stereoscopic display that is visible to the user with naked eyes.
(19) An information processing method, including:
   detecting, by a computer system, an interference object on the basis of a position of a point of view of a user and a position of at least one object that is displayed on a display that performs stereoscopic display depending on the point of view of the user, the interference object interfering with an outer edge that is in contact with a display region of the display; and
   controlling, by the computer system, display of the interference object that is performed on the display such that stereovision contradiction related to the interference object is suppressed.
(20) A program that causes a computer system to perform a process including:
   detecting an interference object on the basis of a position of a point of view of a user and a position of at least one object that is displayed on a display that performs stereoscopic display depending on the point of view of the user, the interference object interfering with an outer edge that is in contact with a display region of the display; and
   controlling display of the interference object that is performed on the display such that stereovision contradiction related to the interference object is suppressed.

### REFERENCE SIGNS LIST

1 user
2 point of view
5, 5a to 5g object
6 interference object
11 camera
12 display panel
13 lenticular lens
display region
16 outer edge
17 display space
20 storage
21 3D application
22 control program
25, 25L, 25R object image
30 controller
31 camera image processor
32 display image processor
33 application execution section
53 display unit
100 stereoscopic display
200 HMD

1. An information processing apparatus, comprising
a display controller that
detects an interference object on a basis of a position of a point of view of a user and a position of at least one object that is displayed on a display that performs stereoscopic display depending on the point of view of the user, the interference object interfering with an outer edge that is in contact with a display region of the display, and
controls display of the interference object that is performed on the display such that stereovision contradiction related to the interference object is suppressed.

2. The information processing apparatus according to claim 1, wherein
the display controller controls the display of the interference object such that a state in which at least a portion of the interference object is hidden by the outer edge is resolved.

3. The information processing apparatus according to claim 1, wherein
the display region is a region on which a pair of object images generated correspondingly to a left eye and a right eye of the user is displayed, the pair of object images being generated for each object, and
the display controller detects, as the interference object, an object that is from among the at least one object and of which an object image of the pair of object images protrudes from the display region.

4. The information processing apparatus according to claim 1, wherein
the display controller calculates a score that represents a level of the stereovision contradiction related to the interference object.

5. The information processing apparatus according to claim 4, wherein
on a basis of the score, the display controller determines whether to control the display of the interference object.

6. The information processing apparatus according to claim 4, wherein
the display controller calculates the score on a basis of at least one of the area of a portion of the object image of the interference object that is situated outside of the display region, a depth that is measured from the display region and at which the interference object is situated, or a set of a speed and a direction of movement of the interference object.

7. The information processing apparatus according to claim 1, wherein
the display controller determines a method for controlling the display of the interference object on a basis of attribute information regarding an attribute of the interference object.

8. The information processing apparatus according to claim 7, wherein
the attribute information includes at least one of information that indicates whether the interference object moves, or information that indicates whether the interference object is operatable by the user.

9. The information processing apparatus according to claim 1, wherein
the display controller performs first processing of adjusting display of the entirety of the display region in which the interference object is situated.

10. The information processing apparatus according to claim 9, wherein
the first processing is at least one of processing of bringing a display color closer to black at a location situated closer to an edge of the display region, or processing of scrolling the entirety of a scene displayed on the display region.

11. The information processing apparatus according to claim 10, wherein
when the interference object is operatable by the user, the display controller performs the processing of scrolling the entirety of a scene displayed on the display region.

12. The information processing apparatus according to claim 1, wherein
the display controller performs second processing of adjusting an appearance of the interference object.

13. The information processing apparatus according to claim 12, wherein
the second processing is at least one of processing of bringing a color of the interference object closer to a color of a background, processing of increasing a degree of transparency of the interference object, processing of deforming the interference object, or processing of making the interference object smaller in size.

14. The information processing apparatus according to claim 1, wherein
the display controller performs third processing of adjusting a behavior of the interference object.

15. The information processing apparatus according to claim 14, wherein
the third processing is at least one of processing of changing a direction of movement of the interference object, processing of increasing a speed of the movement of the interference object, processing of controlling the movement of the interference object, or processing of not displaying the interference object.

16. The information processing apparatus according to claim 15, wherein
when the interference object is operatable by the user, the display controller performs the processing of controlling the movement of the interference object.

17. The information processing apparatus according to claim 1, further comprising
a content execution section that executes a content application used to present the at least one object, wherein
processing performed by the display controller is processing caused by a run-time application to be performed, the run-time application being used to execute the content application.

18. The information processing apparatus according to claim 1, wherein
the display is a stationary apparatus that performs stereoscopic display that is visible to the user with naked eyes.

19. An information processing method, comprising:
detecting, by a computer system, an interference object on a basis of a position of a point of view of a user and a position of at least one object that is displayed on a display that performs stereoscopic display depending on the point of view of the user, the interference object interfering with an outer edge that is in contact with a display region of the display; and
controlling, by the computer system, display of the interference object that is performed on the display such that stereovision contradiction related to the interference object is suppressed.

20. A program that causes a computer system to perform a process comprising:
detecting an interference object on a basis of a position of a point of view of a user and a position of at least one object that is displayed on a display that performs stereoscopic display depending on the point of view of the user, the interference object interfering with an outer edge that is in contact with a display region of the display; and
controlling display of the interference object that is performed on the display such that stereovision contradiction related to the interference object is suppressed.
